(19) United States
(12) Patent Application Publication
(10) Pub. No.: US 2013/0016963 A1
(43) Pub. Date: Jan. 17, 2013

(54) DEVICE FOR FASTENING IMAGING UNITS ON A MICROSCOPE

(71) Applicant: Andrew Miller, The Woodlands, TX (US)

(72) Inventor: Andrew Miller, The Woodlands, TX (US)

(21) Appl. No.: 13/550,260

(22) Filed: Jul. 16, 2012

Related U.S. Application Data
(60) Provisional application No. 61/507,738, filed on Jul. 14, 2011.

(51) Int. Cl. G02B 21/36

(52) U.S. Cl. 396/428

(57) ABSTRACT

A device used to fasten a myriad of imaging units, including a large variety of camera enabled cell phones to a variety of optical systems, such as microscopes, in a non-restrictive, non-specific manor.

### CROSS-REFERENCE TO RELATED APPLICATIONS

This application claims the benefit of U.S. Provisional Patent Application Ser. No. 61/507,738, filed on Jul. 14, 2011, the entire disclosure of which is herby incorporated by reference.

### BACKGROUND

Information and communication technologies have great potential to address some of the challenges faced by both developed and developing countries in providing accessible, cost-effective, high-quality health care services. Telemedicine uses information and communication technologies to overcome geographical barriers, and increase access to health care services. In particular, cell phones and webcams can be used to capture and transmit images from a microscope

Most microscopes, however, are not optimized for use in telemedicine. It is desirable to develop a cost effective way of using modern day microscopes in telemedicine. Similarly, other optical systems generally are not adapted for use with cell phones and webcams.

### SUMMARY

The present disclosure generally relates to a device for fastening imaging units to an eye piece of an optical system.

In one embodiment, the present disclosure provides a device for fastening an imaging unit to an eye piece of an optical system, wherein the device has an adapter component and a platform.

In one embodiment, the present disclosure provides a device for fastening different imaging units on a microscope, wherein the device has an adapter component and a platform that moves with respect to the adapter component.

The features and advantages of the present invention will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 is a schematic illustration of a device for fastening different imaging units on a microscope of the present disclosure, according to one embodiment.

FIG. 2 is a schematic illustration of a device for fastening different imaging units on a microscope of the present disclosure, according to one embodiment.

FIG. 3 is a schematic illustration of a device for fastening different imaging units on a microscope of the present disclosure, according to one embodiment.

FIG. 4 is a schematic illustration of a device for fastening different imaging units on a microscope of the present disclosure, according to one embodiment.

FIG. 5 is a schematic illustration of a device for fastening different imaging units on a microscope of the present disclosure, according to one embodiment.

FIG. 6 is a schematic illustration of a device for fastening different imaging units on a microscope of the present disclosure, according to one embodiment.

FIG. 7 is a schematic illustration of a device for fastening different imaging units on a microscope of the present disclosure, according to one embodiment.

FIG. 8 is a schematic illustration of a device for fastening different imaging units on a microscope of the present disclosure, according to one embodiment.

FIG. 9 is a schematic illustration of a device for fastening different imaging units on a microscope of the present disclosure, according to one embodiment.

FIG. 10 is a schematic illustration of a device for fastening different imaging units on a microscope of the present disclosure, according to one embodiment.

FIG. 11 is a schematic illustration of a device for fastening different imaging units on a microscope of the present disclosure, according to one embodiment.

FIG. 12 is a schematic illustration of a device for fastening different imaging units on a microscope of the present disclosure, according to one embodiment.

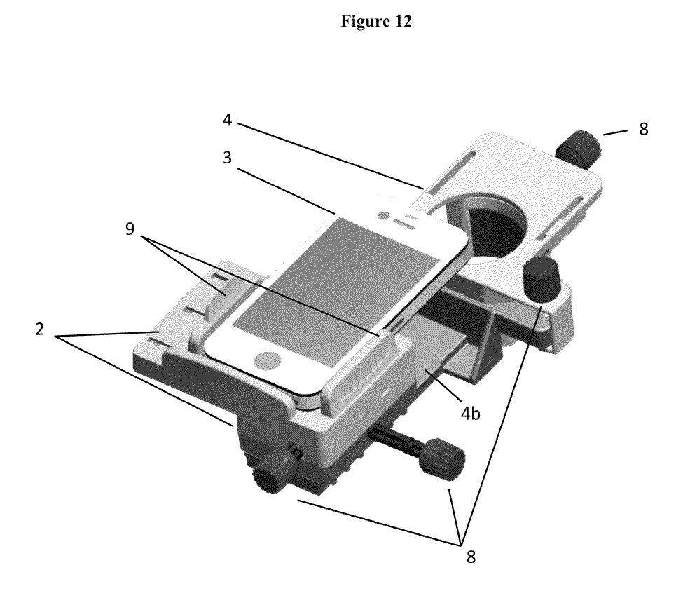

FIG. 13 is a schematic illustration of a device for fastening different imaging units on a microscope of the present disclosure, according to one embodiment.

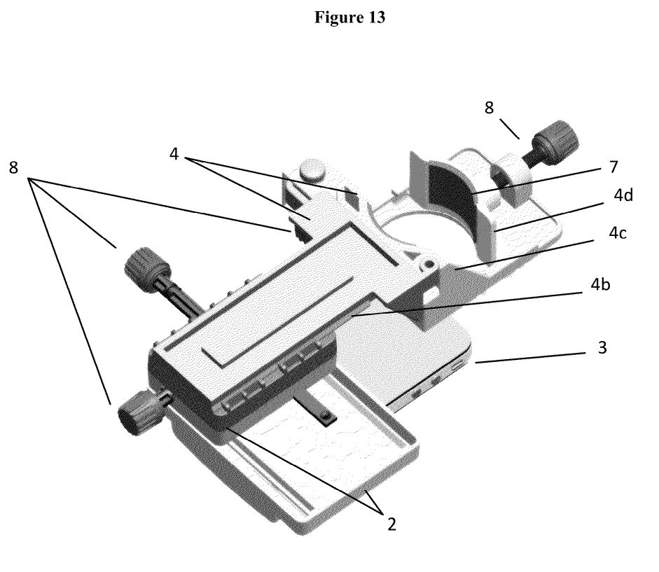

### DESCRIPTION

The present disclosure generally relates to a device for fastening imaging units to an eye piece of an optical system.

The devices of the present disclosure, according to one embodiment, may be capable of fastening a variety of imaging units to an optical system that is easy to manipulate, that is not restricted to specific imaging units nor restricted to specific optical systems, and at the same time can be produced cost-effectively with a minimum of components. The devices of the present disclosure, according to certain embodiments, may be used with any optical system such as, for example, microscopes, telescopes, binoculars, monoculars, spotting scopes, and the like. While in certain embodiments the present disclosure describes a universal mount, the present disclosure contemplates devices adapted for use with specific imaging units in which case the need for a platform that moves with respect to the adapter component may be reduced or minimized and a static platform may be employed. For example, the device present disclosure may be used with a specific phone, in which case the need for translation in all axes may be reduced and the platform may be fixed with respect to the adapter component.

In certain embodiments, the platform may comprise mounting features specific to one imaging device, such as a smartphone. In yet other embodiments, the platform may be shaped to encase a smartphone with specific dimensions and affix the smartphone to the adapter component. In yet other embodiments, the platform can be fixed with respect to the adapter such that the imaging unit on a smartphone is aligned with the optical axis an optical system. In yet other embodiments, the platform can be attached to and released from the adapter component with a variety of mechanisms.

In certain embodiments, the device may attach to any cylindrical shaped component of the microscope such as an eyepiece, a lens tube, or a portion of the microscope housing.

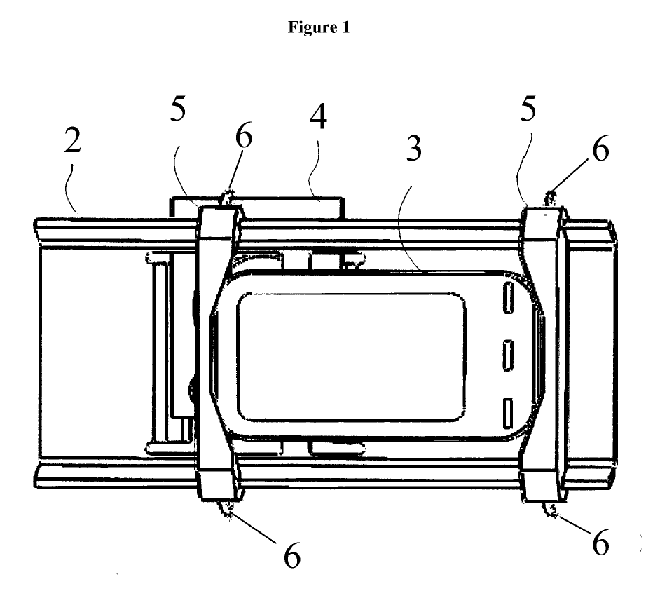

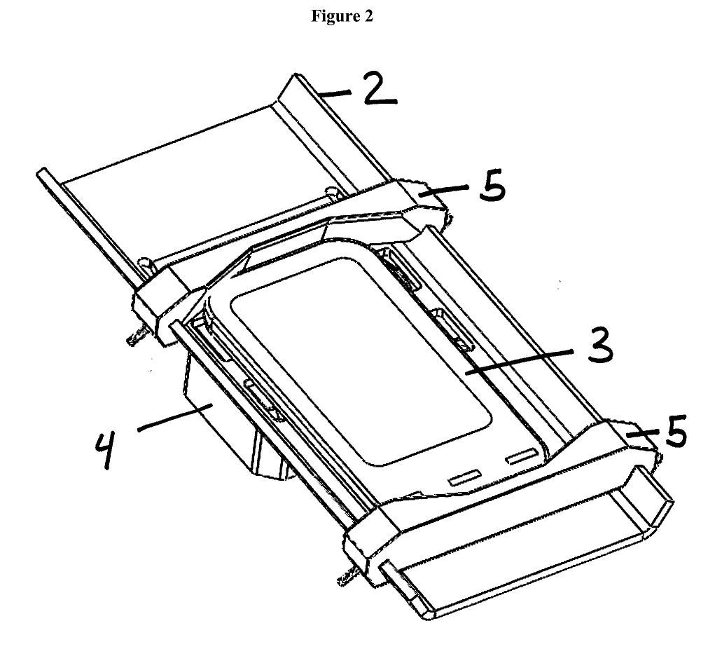

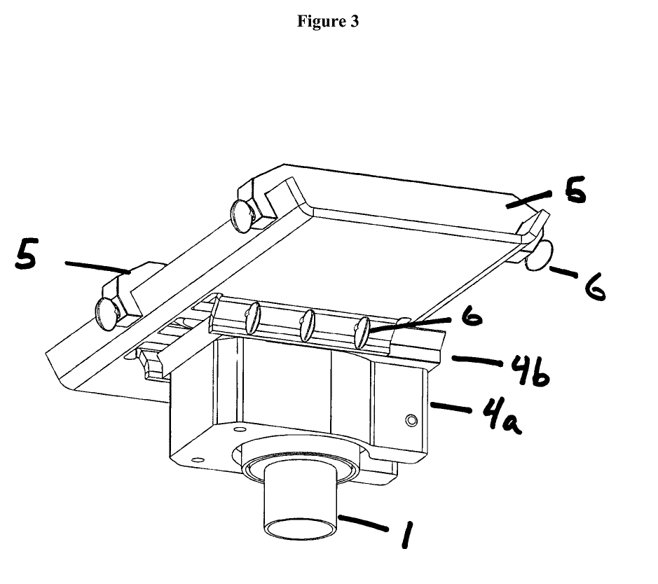

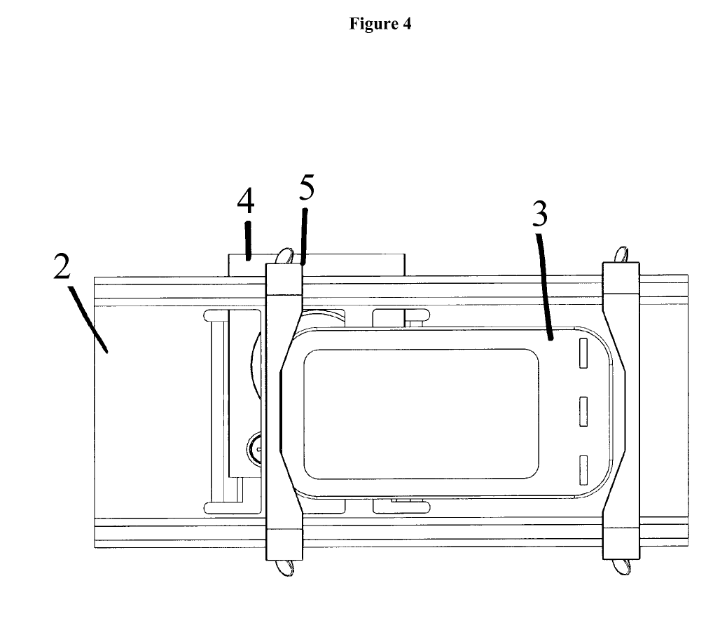

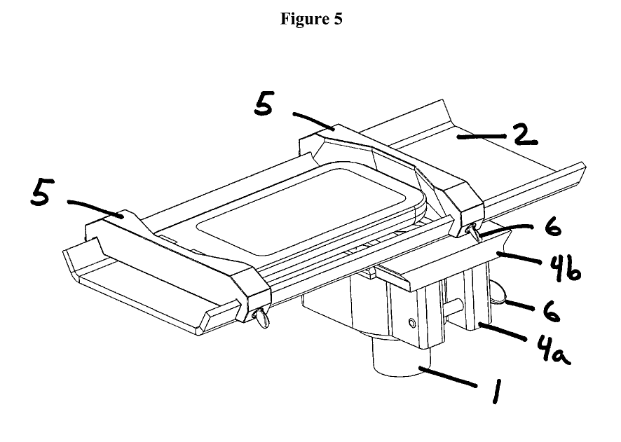

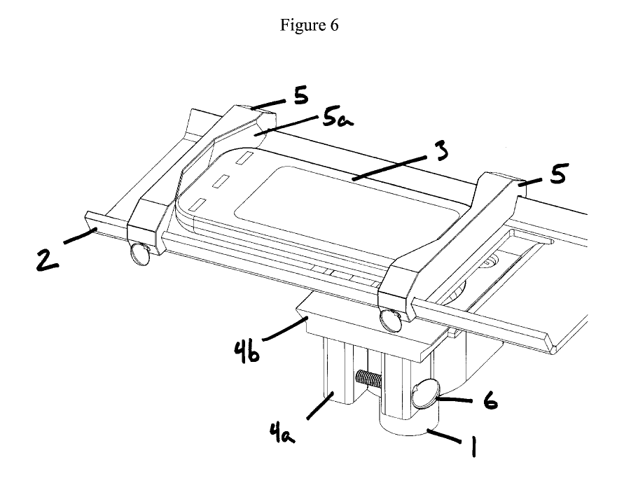

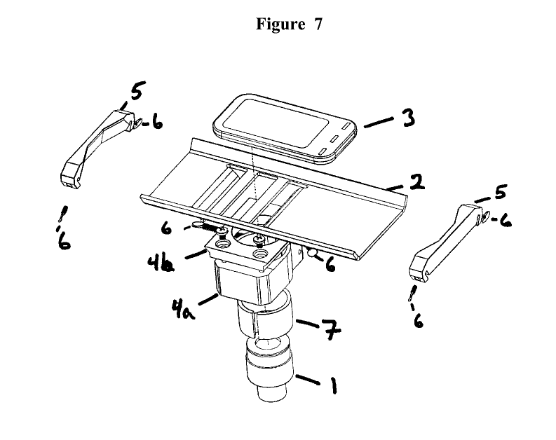

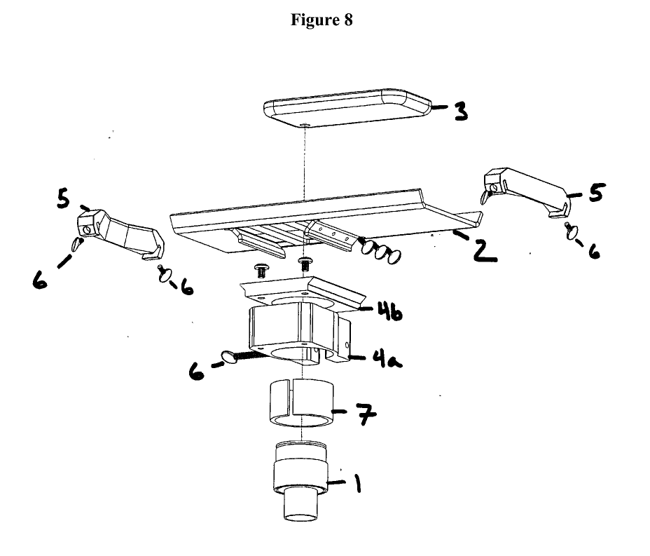

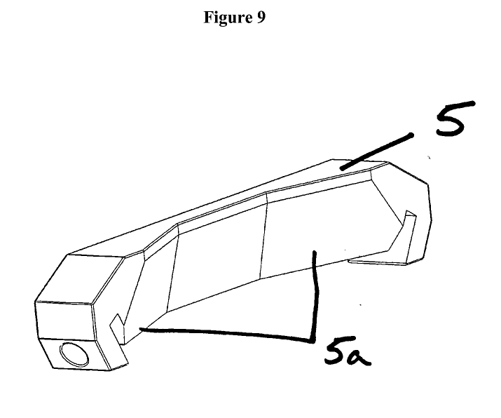

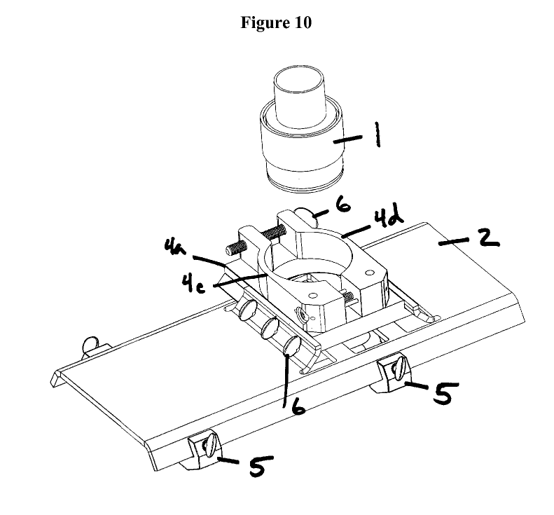

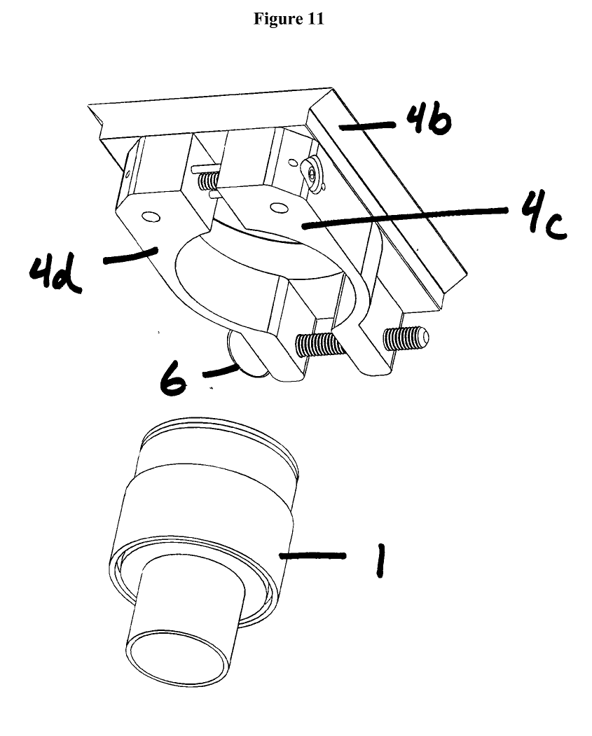

This object may be achieved by a device that in certain embodiments comprises an adapter component (4) surrounding a cylindrical component of the optical system (1) such as an eyepiece of a microscope, a platform (2) that moves with respect to the adapter component (4) and provides a mounting surface for an imaging unit (3) such as a cellphone. FIGS. 1-11 illustrate embodiments of such devices. The adapter component (4) can be moved up and down along the cylindrical component on optical system (1) to bring the imaging unit (3) into the desired position for resolving the image on the imaging unit (3), such as the focal plane created by the eyepiece. The imaging unit (3) can be affixed to the platform (2) at any axial position along the length of the platform (2). The platform (2) holding the imaging unit can move laterally with respect to the adapter component (4) in order to position the imaging unit along the optical axis of the system. The imaging unit (3), platform (2), and adapter component (4) can all be locked in a desired position.

In one embodiment, the device is comprised of an adapter component (4) that further comprises a c-clamp component (4a) that can tighten onto an eyepiece of a microscope (3) with enough force to secure it in place and allow for the assembly to slide along the eyepiece (1). The adapter component (4) further comprises a dovetail component (4b) that may slide in relation to a platform with a mating dovetail element (2). A clip (5) can slide along the platform (2) to hold an imaging unit (3) in a desired position. In certain embodiments, clip (5) may have one or more angled features (5a). The c-clamp component (4a) can be tightened onto a cylindrical component on the microscope system to lock it in a desired position. The platform can be locked in place with respect to the c-clamp component with thumbscrews (6). The imaging unit (3) can be located and locked with respect to the platform (2) with one or more clips. In yet other embodiments, no locking mechanism is required and all components may be stable and immobile due to the resultant combination of gravity forces and friction between mating components.

In some embodiments, the adapter component (4) further comprises a c-clamp that is split into two components. One c-clamp element (4c) may be affixed to the dovetail component (4b) of the adapter component (4). The second c-clamp element (4d) can be moved relative to the first element in order to accommodate large size differences in the cylindrical objects, which may be clamped. In some embodiments, the second c-clamp element may ride on two guide pins that may be affixed to the first c-clamp element. A screw (4e) may move the second c-clamp element.

In some embodiments, the adapter component (4) comprises two components that move in relation to each other along the axis of cylindrical component on optical system (1). The platform (2) moves with respect to the adapter component. The platform (2) further comprises two or more components that can themselves move with respect to each other allowing for lateral translation. The platform (2) further comprises a clamp (9) to hold an imaging device. The platform and adapter components can be moved with one or more screw mechanisms.

In some embodiments, translation of any or all of the adapter (4), platform (2), or clip components (5) is performed with screw mechanisms.

In some embodiments, the clip (5) may have angled faces that orient and center a rectangular shaped imaging device.

In some embodiments, the platform and/or clip positions can be adjusted with precision screws.

In some embodiments, one or more clip can be used to hold the imaging device in the desired location on the platform and the clip can have guiding features to center and hold captive the imaging device against the platform.

In some embodiments, the imaging unit may be a cellphone. In other embodiments, the imaging unit may be a webcam. In yet other embodiments, the imaging unit may be a camera or video camera.

In some embodiments, the cylindrical component on the microscope system may be an eyepiece. In other embodiments, the cylindrical component may be a lens tube. In other embodiments, the cylindrical component may be a component of the microscope housing.

In some embodiments, the adapter component may be a c-clamp where a screw may be used to tighten, loosen, lock and/or release the c-clamp. In other embodiments, the adapter component may be a c-clamp with a cam lock, sometimes referred to as a quick release lever, and may be used to tighten, loosen, lock and/or release the c-clamp. In other embodiments, the adapter component may be a ratcheting mechanism. In yet other embodiments, the adapter component may maintain a tight fit with the cylindrical component on the microscope so that a force must be applied by a user to move the device but the device is otherwise stable and immobile. Such an embodiment could comprise a cylinder and an O-ring to provide a sliding friction fit with respect to a cylindrical component on the microscope.

In some embodiments, a sleeve (7) changes the outside diameter of the cylindrical shape on the optical system (1) in order to form a good fit with the adapter component (4).

In some embodiments, to facilitate the finding of previously determined positions, the displacement of the device with respect to the microscope can be demarked with markings on the device, such as ruler markings on the adapter component. In some embodiments, to facilitate the finding of previously determined positions, the displacement of the platform with respect to the adapter component can be demarked with markings on the platform and adapter component, such as ruler markings on the adapter component. In some embodiments, to facilitate the finding of previously determined positions, the location of the imaging unit with respect to the platform can be demarked with markings on the device, such as ruler markings on the platform.

In some embodiments, the adapter component moves in relation to the platform utilizing dovetail features. In other embodiments, the adapter component moves in relation to the platform utilizing slots and pins. In other embodiments, the adapter component moves in relation to the platform utilizing sliding rails.

In some embodiments, the adapter component can be an assembly of subcomponents. In other embodiments, one subcomponent clamps onto the cylindrical component on optical system (1) and a second subcomponent (4b) comprises a dovetail rail element on which the platform (2) can translate. The subcomponents of the adapter component can slide with respect to each other to facilitate translation along the axis of the cylindrical component on optical system (1). In other embodiments, the translation of the subcomponents of the adapter component can be actuated one or more screw mechanisms.

In certain embodiments, the platform may include a clamping mechanism. Any clamping mechanism capable of securing the imaging unit may be suitable. Examples of suitable clamping mechanisms include, but are not limited to a pair of plates that apply pressure to the imaging unit, a spring or screw or ratcheting mechanism that applies pressure to the imaging unit, or a friction fit.

In yet other embodiments, the platform can encase an imaging unit and hold that imaging unit fixed with respect to an adapter component.

In some embodiments, the present device can be manufactured out of a variety of materials through traditional machining The present device can be manufactured out of virtually any metal or plastic including aluminum, steel, stainless steel, Delrin, Polypropylene, Polycarbonate, PVC. In other embodiments, the device may be made from bent sheet metal. In yet other embodiments, the present device may be made from molded plastic. In yet other embodiments, the present device may be made from machined metals or plastics.

In certain embodiments, the present disclosure describes a method for affixing an imaging unit to an optical system comprising: clamping an adapter component to a cylindrically shaped component on the optical system, such as an eye piece; clamping an imaging unit to a platform which may translate with respect to the adapter component; if necessary, translating the imaging unit with respect to the platform and/or the platform with respect to the adapter component such that the imaging unit is translated in a controlled fashion in one or up to three axes with respect to the optical system; capturing images with the imaging unit; and recording and/or transmitting captured images.

The features and advantages of the present invention will be apparent to those skilled in the art. While numerous changes may be made by those skilled in the art, such changes are within the spirit of the invention.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

What is claimed is:

1. A device comprising
an adapter component adapted to fasten an imaging unit on a microscope and
a platform that moves with respect to the adapter component.

2. The device of claim 1 wherein the adapter component is fastened to the microscope at the eye piece or lens tube.

3. The device of claim 1 further comprising an imaging unit fastened to the platform.

4. The device of claim 1 wherein the adapter component comprises a c-clamp.

5. The device of claim 1 wherein the adapter component comprises a c-clamp actuated by a screw or a c-clamp actuated by a cam lever.

6. The device of claim 1 wherein the adapter component comprises an over-center latch.

7. The device of claim 1 wherein the adapter component is a c-clamp with an incorporated dovetail element, is a c-clamp with an incorporated rail feature, is a c-clamp with an incorporated rail feature and dovetail element, or is split into two pieces that move closer or further apart from one another.

8. The device of claim 1 wherein the adapter component comprises one or more screw mechanism for actuating the platform.

9. The device of claim 1 wherein platform incorporates a dovetail feature, a rail feature, or a rail feature actuated by a screw mechanism.

10. The device of claim 1 wherein the platform has side walls.

11. The device of claim 1 wherein the platform has side walls and a clip is incorporated to slide along the walls of the platform and demark a desired position for an imaging unit.

12. The device of claim 1 wherein the clip has angled faces that orient and center a rectangular imaging device.

13. The device of claim 1 wherein the platform has side wall and set screws to locate and lock an imaging unit into a desired position.

14. The device of claim 1 wherein the platform has one or more screw mechanisms.

15. The device of claim 1 wherein the multiple platforms translate in independent directions and interface with each other and the adapter component.

16. The device of claim 1 wherein a specialized case specific to a particular cell phone can be clipped onto a platform that affixes the cell phone in a desired location.

17. The device of claim 1 wherein a the platform comprises a clamping mechanism to hold an imaging device.

18. A device comprising
an adapter component adapted to hold an imaging unit in an optical axis of an optical system and
a platform connected to the adapter component, wherein the platform is adapted to retain the imaging unit.
